(19) United States
(12) Patent Application Publication
(10) Pub. No.: US 2002/0125182 A1
(43) Pub. Date: Sep. 12, 2002

(54) Filter element for water treatment

(76) Inventor: Ryodo Kijima, Tokyo (JP)

Correspondence Address: R. Neil Sudol, COLEMAN SUDOL SAPONE, P.C., 714 Colorado Avenue, Bridgeport, CT, 06605-1601, US

(21) Appl. No.: 10/014,168

(22) Filed: Dec. 11, 2001

(30) Foreign Application Priority Data
Jan. 11, 2001 (JP) 2001-039229

(51) Int. Cl. B01D 1/00

(52) U.S. Cl. 210/209

(57) ABSTRACT

To make a filter element for water treatment capable of substantially completely removing dioxins contained in water, a first water treatment material 20 and a second water treatment material are 30 filled and disposed within a housing 10 with a water inlet 11 and a water outlet 12, in which water passes through the both water treatment materials 20 and 30, and the first water treatment material 20 is constituted of a superposed layer of four layers or more layers 21a, 21b, 21c, 21d, 21e, made of a ceramic solid 101 containing a ferrous and ferric salt represented by the following formula:

Fe⁺²ₘFe⁺³ₙCl₂ₘ₊₃ₙ

wherein m and n are each a positive integer. When water that has been introduced into the housing 10 passes through the first water treatment material 20, the water comes into contact with the ceramic solids 101 of the layers 21a, 21b, 21c, 21d, 21e to cause a reaction, whereby the dioxins contained in the water are decomposed and substantially completely removed.

### BACKGROUND OF THE INVENTION

1. Field of the Invention

The present invention relates to a filter element for treating water such as tap water. More specifically, the invention relates to a filter element for water treatment provided with a water treatment material constituted of a layer of a ceramic material containing a ferrous and ferric salt.

2. Description of the Conventional Art

In recent years, the research in the biological chemistry has been promoted, and a novel active substance of a ferrous and ferric salt represented by Fe⁺²ₘFe⁺³ₙCl₂ₘ₊₃ₙ (wherein m and n are each a positive integer) has been developed. This active substance (ferrous and ferric salt) is an inorganic salt, such as hydrochlorides, sulfates, and nitrates, or an organic salt, such as formates, acetates and prorionates, of an iron exhibiting intermediate properties between divalent ferrous iron and trivalent ferric iron. For example, in the case where ferric chloride is added to an aqueous solution of a strong alkali such as sodium hydroxide, calcium hydroxide, potassium hydroxide, and lithium hydroxide, to cause valence conversion, this active substance is obtained in a transition state and can be produced at present on an industrial scale (see Japanese Patent Publication Nos. 63593/1991 and 27171/1992).

It is already clarified that when the active substance of ferrous and ferric salt is brought into contact with water, it exhibits the following action. That is, it is clarified that when a ultra-micro amount of the active substance is incorporated into normal water (a concentration: 2×10⁻¹² moles=1/2,000,000,000,000), a 1/2,000,000,000,000% aqueous solution of this substance(for the sake of convenience, this aqueous solution will be hereinafter referred to as “piwater”) has the following characteristics.

(Structure change in water molecule)

Usually, with respect to a water molecule, centers of gravity of hydrogen and oxygen do not coincide, and hence, plus and minus polarities are generated. For this reason, since the water molecule is bound in a cage-like state by hydrogen bond, it dissolves hydrocarbons, methane, gases, and the like into the cage. In contrast, with respect to the piwater, the water molecule and the bonding structure of the water molecule are changed from a polar molecule to a non-polar molecule, that is, the centers of gravity of H (hydrogen) and O (oxygen) coincide, thereby eliminating the bipolarity. In other words, the water molecule itself does not have plus and minus polarities. As a result, the piwater does not dissolve hydrocarbons and the like therein unlikely as the usual water.

(Deionization reaction)

Usually, metals and metal salts are caused with ionic dissociation in water, whereby material changes mainly composed of ionization reaction take place. In contrast, in the piwater, since it does not have plus and minus polarities, dissociation of metal ions is inhibited from taking place to form a nonionic reaction system.

(Fluctuation in gas expansion coefficient)

In the case where the piwater and a gas (air) are co-exist in the same system, an apparent expansion coefficient to temperature of the gas fluctuates with the temperature. In other words, with respect to distilled water, the air volume linearly increased in proportion to an increase of the temperature. In contrast, with respect to the piwater, the expansion coefficient changed along a curve having an inflection point in the vicinity of 22° C.

(Change in potential difference)

Usually, in water, a potential difference increases with an increase of metal ions. In contrast, in the piwater, since it inhibits ionic dissociation, the potential difference decreases, leading to removal of heavy metal ions contained therein.

(Effect for stabilizing pH)

Usually, a degree (amount) of acidic substances and alkaline substances contained in water determines a pH. In contrast, in the piwater, acidic substances (e.g., sulfide ions) and alkaline substances (e.g., hydroxide ions) are controlled so as to inhibit ionic dissociation and to be stabilized in a neutral state.

(Prevention of pathogenic bacteria)

Various germs including bacteria are single cell microorganisms having a minus charge and inhabit in an ionic reaction system of normal water. In contrast, the ionic reaction is inhibited in piwater, and an equilibrium state of the various germs is changed. For this reason, in the piwater, the various germs are laid in an environment that neither proliferation nor inhabitation is possible.

As discussed above, it has already been experimentally proven that the above-described active substance changes the structure of the water molecule and activates it. At present, this active substance is widely used as a water modifying and activating agent.

Further, the present inventor previously developed a water modifying and activating agent constituted of a ceramic solid containing the above-described ferrous and ferric salt (see Japanese Patent Laid-Open No. 184387/1990). And, it is already clarified that when normal water is brought into contact with the above-described ceramic solid, the water is converted into piwater, and this ceramic solid is being used as a water treatment material in a filter element for water treatment.

Filter elements for water treatment provided with a water treatment material constituted of a layer of a ceramic solid containing the above-described ferrous and ferric salt are disclosed in, for example, U.S. Pat. No. 5,205,931 and Japanese Patent Laid-Open Nos. 211701/1994, 211702/1994 and 2000-279959. These filter elements are provided with a layer of the above-described ceramic solid within a housing provided with a water inlet and a water outlet, so that water is treated by making it pass through a water treatment material comprising the above-described housing and the above-described layer. According to these filter elements, it is possible to convert normal water such as tap water into piwater having the characteristics as specified above.

Now, in recent years, the environmental pollution by dioxins is of a great problem. The term “dioxin” is a common name of polychlorodibenzodioxins and is dealt as dioxins while including polychlorodibenzofurans. It has already become clear through animal tests that the dioxins have a strong acute toxicity. In addition, the dioxins are suspicious of being carcinogenic and teratogenetic. The dioxins are unintentionally formed during steps of combustion or production of chemical substances, or other steps, and are discharged into the environment as impurities of combustion gases or chemical substances. As a specific example, there is pointed out a problem that water of, e.g., river, lake, and sea is polluted by the dioxins in an industrial liquid waste. For this reason, there is a possibility that the dioxins are contained in tap water utilizing water of a river, etc. as a source of water. However, filter elements for water treatment capable of completely removing the dioxins contained in water have not been proposed yet.

Thus, the present inventor made investigations and experiments repeatedly. As a result, it was found that a ceramic solid containing the above-described ferrous and ferric salt has an action to remove dioxins contained in water. That is, it was found that when a filter element comprising a layer of the above-described ceramic solid disposed within a housing is used, and dioxins-containing water is made to pass through the filter element, not only the above-described characteristics but also a characteristic to remove the dioxins (it is considered that the dioxins are decomposed and removed) are realized. In this experiment used was a filter element having one layer of a number of the above-described ceramic solids formed within the housing, likewise the filter for water treatment as illustratively disclosed above. However, though it was clarified that when the dioxins-containing water passes through this filter element, an action to remove the dioxins contained in water was realized, such an action was not satisfactory yet from the viewpoint of a removal rate. Incidentally, the above-described experiment and numerical values of the removal rate and so on will be described later.

### SUMMARY OF THE INVENTION

Under the above background, the present invention has been made and is aimed to provide a filter element for water treatment capable of substantially completely removing dioxins contained in water.

In order to achieve the above-described aim, the present inventor made further investigations and experiments, leading to accomplishment of the invention.

Specifically, the filter element for water treatment of the present invention is a filter element for water treatment having a water treatment material disposed within a housing with a water inlet and a water outlet, in which water passes through the housing and the water treatment material, wherein the water treatment material is constituted of a superposed layer of four layers or more layers, made of a ceramic solid containing a ferrous and ferric salt, and the ferrous and ferric salt is a compound represented by the following formula:

Fe⁺²ₘFe⁺³ₙCl₂ₘ₊ₙ

wherein m and n are each a positive integer.

### BRIEF DESCRIPTION OF THE DRAWINGS

FIG. 1 is a longitudinal sectional view showing the whole structure of one embodiment of the filter element for water treatment according to the present invention;

FIG. 2 is a longitudinal sectional view illustratively showing one layer among a plurality of layers made of a ceramic solid containing a ferrous and ferric salt employed in the water treatment material of the filter element for water treatment according to the present invention;

FIG. 3 is a perspective view showing a main body portion of a container of the layer of FIG. 2;

FIG. 4 is explanatory views showing a production step of the above-described ceramic solid, in which FIG. 4A is an explanatory view showing a step for producing a constitutional raw material of a ceramic substrate, FIG. 4B is an explanatory view showing a step for producing a molded article of the ceramic substrate, and FIG. 4C is an explanatory view showing a complete article of the ceramic solid;

FIG. 5 is an explanatory view showing one embodiment of a water purifier using the above-described filter element for water treatment; and

FIG. 6 is an explanatory view showing an outline of a test apparatus used for carrying out a test for removal properties of dioxins according to the water purifier of FIG. 5.

### DESCRIPTION OF THE PRFERRED EMBODIMENTS

As described above, the compound represented by the foregoing formula is an inorganic salt, such as hydrochlorides, sulfates, and nitrates, or an organic salt, such as formates, acetates, and prorionates, of an iron exhibiting intermediate properties between divalent ferrous iron and trivalent ferric iron. For example, in the case where ferric chloride is added to an aqueous solution of a strong alkali such as sodium hydroxide, calcium hydroxide, potassium hydroxide, and lithium hydroxide, to cause valence conversion, this compound is obtained in a transition state. As a specific process for producing this compound, the following steps are, for example, exemplified. That is, the production process includes a step for dissolving ferric chloride in an aqueous solution of a strong alkali, a step for neutralizing this solution with hydrochloric acid, and a step for concentrating the neutralized solution to obtain crystals.

Further, a ratio of m and n in the foregoing formula takes a specified numerical value depending on a chemical species of a base material in the production of the compound, and the like.

When dioxins-containing water is introduced into the housing from the water inlet of the filter element for water treatment having the above-described structure according to the present invention, the water passes through each of a plurality of layers made of the ceramic solid and flows out the housing from the water outlet. And, during passing through each of the layers, the water comes into contact with the ceramic solid of each layer and reacts with it, whereby the dioxins contained in the water are decomposed. After passing through all of the layers, the dioxins are substantially completely removed. Thus, according to the present invention, it is possible to remove substantially 100% of the dioxins contained in the water. This fact has become clear as the result of experiments.

In the present invention, each of the layers of the water treatment material can be constituted by accommodating a desired number of the ceramic solids within a container provided with many small holes. Further, each of the above-described layers can be constituted by accommodating a desired number of the ceramic solids within a network-like container. Moreover, each of the above-described layers can be constituted by providing a partition to be inserted between the each two layers made of a desired number of the ceramic solids, without using the above-specified containers.

In the present invention, the ceramic solids can be formed in a ball-like state. Further, the ceramic solids can be formed in a porous state with numerous fine pores.

In addition, in the present invention, it is possible to dispose a second water treatment material separately from the above-described water treatment material, in a water passage within the housing. The second water treatment material can be constituted of one or more layers selected from a layer made of a calcium-containing material, a layer made of a dechlorinating agent, a layer made of active carbon, a layer made of a mineral components-containing solid, and a layer made of a ceramic material for pH adjustment. When the above-enumerated layer or layers are selected and employed for the second water treatment material, water, which has been treated according to the characteristics of the above-described component in each of the layers, is obtained.

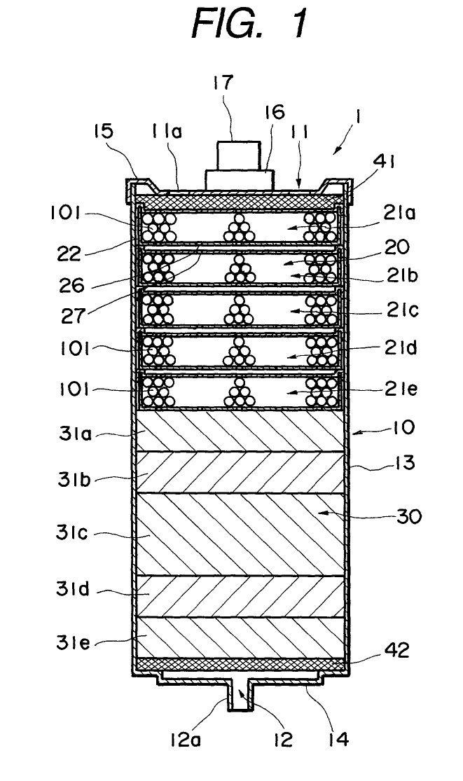

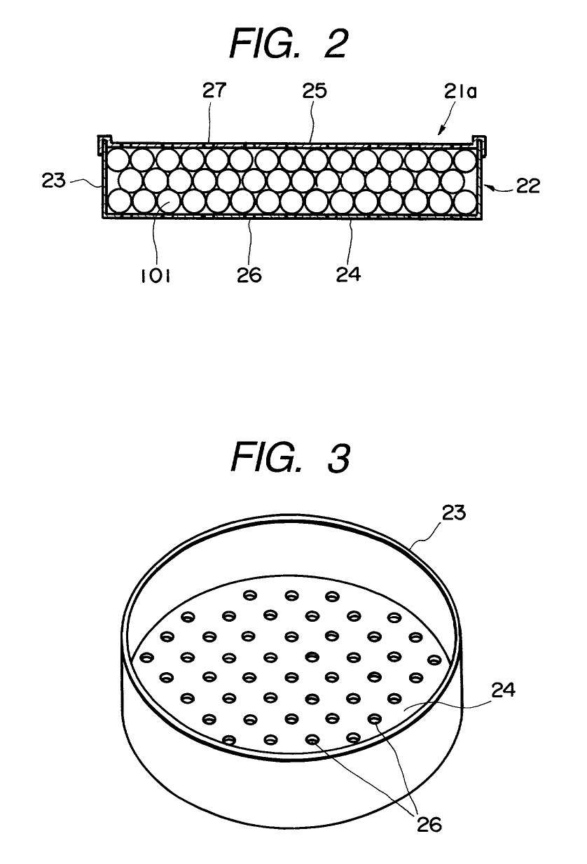

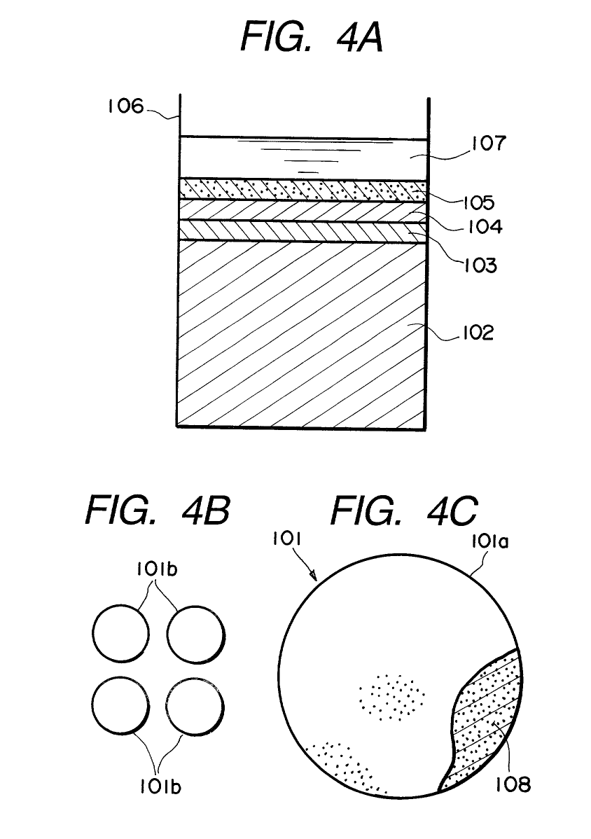

One embodiment of the invention will be described below with reference to the accompanying drawings. FIG. 1 is a longitudinal sectional view showing the whole structure of one embodiment of the filter element for water treatment according to the present invention; FIG. 2 is a longitudinal sectional view illustratively showing one layer among a plurality of layers made of a ceramic solid containing a ferrous and ferric salt employed in the water treatment material of the filter element for water treatment according to the present invention; FIG. 3 is a perspective view showing a main body portion of a container of the layer of FIG. 2; and FIG. 4 is explanatory views showing a production step of the above-described ceramic solid.

In these FIGS. 1 to 4, as a filter element 1 for water treatment according to this embodiment, disclosed is one structured in a form of cartridge filter for water purifier, which has a housing 10, and a first water treatment material 20 and a second water treatment material 30, each of which is disposed within the housing 10. The inside of the housing 10 is substantially divided into two parts of the first water treatment material 20 and the second water treatment material 30. Further, in the housing 10 illustrated in FIG. 1, provided are filters 41, 42 made of glass fibers, etc., which are laid on an upper surface portion of the first water treatment material 20 and on a lower surface portion of the second water treatment material 30, respectively.

The housing 10 is provided with a water inlet 11 and a water outlet 12. The housing 10 according to this embodiment is comprised of a cylinder body 13 with an appropriate diameter and length, having a bottom plate 14 in one end thereof (a lower end in FIG. 1) and a lid member 15 fitly provided in an opening upper end portion of the cylinder body 13. The water inlet 11 is structured of an arbitrary number of holes 11a provided in the lid member 15, and the water outlet 12 is structured of a discharge pipe 12a provided in and protruded from a central portion of the bottom plate 14. Further, a base member 16 is fixedly provided in a central portion of the lid member 15, and a screw cylinder member 17 is fixedly provided on the base member 16. Thus, it is structured such that the water introduced into the housing 10 from the water inlet 11 passes through the filter 41, the first water treatment material 20, the second water treatment material 30, and the filter 42 and is treated, and then flows out the housing 10 from the water outlet 12.

The first water treatment material 20 is constituted of a superposed layer of four or more layers 21a, 21b, 21c, 21d, 21e (fiver layers in FIG. 1), made of a ceramic solid 101 containing a ferrous and ferric salt.

The ferrous and ferric salt is a compound represented by the following formula:

Fe⁺²ₘFe⁺³ₙCl₂ₘ₊₃ₙ

where in m and n are each a positive integer. The ceramic solid 101 is a ceramic substrate 101a having the above-described compound contained therein. The ceramic solid 101 is formed so as to have an appropriate size and form. According to this embodiment, as shown in detail in FIG. 4, the ceramic solid 101 is formed in a ball-like state having a diameter of, for example, about 5 to 15 mm. A constitutional raw material of the ceramic substrate 101a is composed mainly of clay, into which suitable amounts of desired additives are incorporated. Further, it is preferred that the ceramic solid 101 is formed in a porous state provided with numerous fine pores. As the means for so forming, it is simple to incorporate a suitable amount of sawdust in the raw material of the ceramic substrate 101a on the production.

A suitable baking temperature of the ceramic substrate 101a is about 800° C. to about 1,100° C. Though the baking time is not particularly limited, it has become clear as the result of experiment that the baking time is preferably about 10 hours to about 30 hours. It is sufficient that an amount of the active substance of the ferrous and ferric salt is very small. For example, the aim can be achieved by adding about 0.1% to about 1.0% of the active substance into water (preferably distilled water) to be used for keading to form the raw material of the ceramic substrate 101a into a desired size and form, i.e., by using an aqueous solution of distilled water and about 0.1% to about 1.0% of the active substance containing therein as water for kneading the clay.

The respective layers 21a, 21b, 21c, 21d, 21e made of the ceramic solid 101 according to this embodiment are constituted by accommodating a desired number of the ceramic solids 101 in a container 22 provided with many small holes. FIG. 2 shows one representative example thereof in detail. That is, the container 22 is structured so as to have a size corresponding to the inner diameter of the cylinder body 13 of the housing 10 and is comprised of a dish-like container main body 23 with a circular flat bottom having a bottom plate 24 provided in a bottom portion thereof and a lid body 25 fitly provided on an opening upper end portion of the container main body 23. The bottom plate 24 and the lid body 25 are diffusely provided with many small holes 26, 27. And, the container 22 accommodates a desired number of the ceramic solids 101 to constitute the layer 21a.

Each of the layers 21b, 21c, 21d and 21e other than the layer 21a is constituted in the same manner as in the layer 21a. These layers 21a, 21b, 21c, 21d, 21e are each superposed and accommodated within the cylinder body 13 of the housing 10 to constitute the first water treatment material. Incidentally, the layers 21a, 21b, 21c, 21d, 21e can also be constituted by accommodating a desired number of the ceramic solids 101 within a network-like container (not shown) instead of the container 22. Further, the layers 21a, 21b, 21c, 21d, 21e can also be constituted by partitioning with a filter (not shown) provided by inserting between each two of the layers 21a, 21b, 21c, 21d, 21e made of a desired number of the ceramic solids 101, without using the container 22. In other words, the respective layers 21a, 21b, 21c, 21d, 21e can be constituted by directly accommodating a desired number of the ceramic solids 101 within the housing 10 while sandwiching them by the filters.

Next, one example of a specific production process of the ceramic solid 101 will be described below. First of all, the active substance of the ferrous and ferric salt represented by the foregoing formula can be, for example, produced in the following method. That is, 1.0 mg of ferric chloride is added to 100 ml of an aqueous 0.5 N sodium hydroxide solution and dissolved therein while stirring, followed by allowing the solution to stand for 24 hours. After removing insoluble matters formed in the solution, the residual solution is neutralized with hydrochloric acid and concentrated in vacuo. The concentrate is dried in a desiccator to form crystals. To the resulting crystals, added is 80 ml of an aqueous 80% by weight isopropyl alcohol solution for re-dissolution. After concentration in vacuo, the solvent is removed, and the residue is dried. The re-dissolution, concentration and drying are repeated several times, to obtain 0.25 mg of crystals (the active substance of the ferrous and ferric salt).

Next, the ceramic solid 101 can be, for example, produced in the following method. That is, as shown in FIG. 4, 70% by weight of clay (powder) as a main raw material of the ceramic substrate 101a is compounded with 10% by weight of zeolite (powder) , 10% by weight of alumina (powder) and 10% by weight of sawdust as additives. And, as shown in FIG. 4A, these raw materials, i.e., clay 102, zeolite 103, alumina 104, and sawdust 105, are charged in an appropriate container 106, and a suitable amount of an aqueous solution (distilled water) 107 containing about 0.5% of the ferrous and ferric salt (active substance) is added thereto. The mixture is uniformly kneaded with stirring and formed in a desired shape (for example, in a ball-like state having a diameter of about 10 mm) (see FIG. 4B). Then, a thus formed article 101b is baked at an appropriate temperature (for example, from about 800° C. to about 1,100° C.) for an appropriate period of time (for example, about 10 hours to about 30 hours) Thus, the formed article 101b is baked and solidified in a ceramic-like state, and at the same time, the ferrous and ferric salt is sintered and uniformly stays within the ceramic substrate 101a. Moreover, the sawdust is burned, and numerous fine pores (chambers) 108 are formed over the whole of the ceramic substrate 101a, to prepare the ceramic solid 101 (see FIG. 4C).

When the thus prepared ceramic solid 101 is put into water, the water penetrates into the ceramic substrate 101a through the pores (chambers) 108 of the ceramic substrate 101a and comes into contact with the above-described active substance to cause a reaction, which, in addition to the characteristics as specified above, exhibits an action to decompose and remove dioxins contained in the water. Further, since the above-described active substance is integrally sintered with and stays within the ceramic substrate 101a, it does not elute into the water at once but retains within the substrate to exhibit the action continuously and stably over a long period of time (an effective time period for action is about 1 year to about two years).

The second water treatment material 30 is filled and disposed in a lower half portion of the cylinder body 13 of the housing 10 as shown in FIG. 1. The second water treatment material 30 treats the water that has been treated upon passing through the first water treatment material 20, for the purpose different from that of the first water treatment material 20. The second water treatment material 30 can be constituted of an optional material. By superposing five layers 31a, 31b, 31c, 31d, 31e, made of a different material from each other, the second water treatment material 30 according to this embodiment is constituted.

The layer 31a that is one of the five layers is constituted of a layer made of a calcium-containing material. This layer 31a can be formed by seashells, coral or the like. Typically, the materials of the calcium layer 31a are ground quite fine, but small pebble-like can be used. When the water passes through the layer 31a, the calcium component elutes out extremely little by little, so that the action endures over a long period of time.

The layer 31b that is one of the other four layers is constituted of a layer made of a dechlorinating agent. As the dechlorinating agent, can be optionally selected and employed any known materials having an action to remove chlorine contained in water. When the water passes through the layer 31b, chlorine contained in water such as tap water is removed. Incidentally, it is preferred to select and employ a material for the dechlorinating agent, an action of which endures over a long period of time.

The layer 31c that is one of the other three layers is constituted of a layer made of active carbon. As generally known, the active carbon has not only an action to remove odors of water, such as malodors including musty odor and ammoniacal odor but also an action to remove chlorine. Further, the layer 31c made of active carbon has an action to remove impurities having a size of about 1 μm or larger. Accordingly, when the water passes through the layer 31c made of active carbon, not only the odors of water such as malodors are removed, but also residual chlorine is removed, whereby the water becomes clean water.

The layer 31d that is one of the other two layers is constituted of a layer made of a mineral components-containing solid. Examples of the solid that can be used include particles of natural stones such as Bakuhanseki (a trade name) and Bakkaseki (a trade name) , and ceramic sintered materials formed of these stones ground into an appropriate size. When the water passes through the layer 31d, the mineral components of the solid elute out extremely little by little, so that the action endures over a long period of time.

The remaining layer 31e is constituted of a layer made of a ceramic material for pH adjustment. As the ceramic material, employable is that which is constituted similarly to the ceramic solid 101 used in the first water treatment material 20. When the water passes through the layer 31e, the pH of the water is adjusted to be weakly alkaline. Incidentally, as described above, the water introduced into the housing 10 is adjusted for the pH during passing through the first water treatment material 20. However, when the water passes through the layer 31e, the pH is stably adjusted to be weakly alkaline.

With respect to each of the layers 31a, 31b, 31c, 31d, 31e of the second water treatment material 30, desired amounts of the respective materials are separately accommodated within the container 22, and these layers are superposed within the cylinder body 13. Alternatively, the respective materials can be filled within the cylinder body 13 by inserting a filter between each two of the layers 31a, 31b, 31c, 31d, 31e in the same manner as described previously.

The filter element 1 for water treatment according to this embodiment is constituted as above. When water is introduced into the housing 10 from the water inlet 11, the water passes through the filter 41, the first water treatment material 20, the second water treatment material 30, and the filter 42 and then flows out the housing 10 from the water outlet 12. During passing through each of the layers 21a, 21b, 21c, 21d, 21e of the first water treatment material 20, the water comes into contact with the ceramic solid 101 of each layer to become piwater having the characteristics as described above. As the same time, the water comes into contact with the solid of each of the layers 21a, 21b, 21c, 21d, 21e to cause a reaction, whereby the dioxins contained in the water are decomposed and substantially completely removed during passing through each of the layers 21a, 21b, 21c, 21d, 21e. The resulting water is then introduced into the second water treatment material 30. When the water passes through each of the layers 31a, 31b, 31c, 31d, 31e of the second water treatment material 30, the water is treated in the manner as described above and elutes out from the water outlet 12. It is clarified that the water, which has been treated and passed through the housing 10, is extremely effective for health maintenance of human being.

In the above-described embodiment, the filter element for water treatment structured in a form of the cartridge filter for water purifier has been disclosed. However, this is merely disclosed as one example, and as a matter of course, it should not be construed that the present invention is limited to this embodiment.

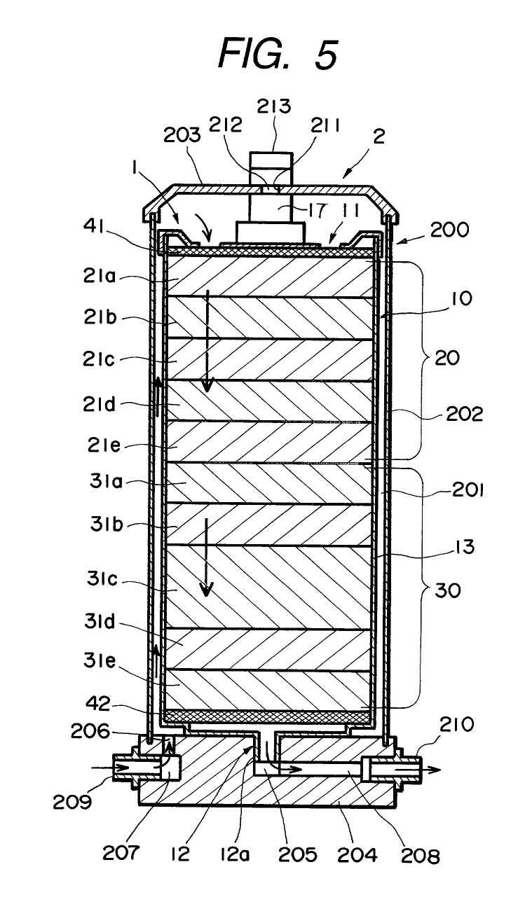

FIG. 5 discloses one embodiment of a water purifier 2 using the filter element 1 for water treatment according to the above-described embodiment. This water purifier 2 has a housing 200 accommodating the filter element 1 so as to be freely detachably.

The housing 200 has a cylindrical accommodation cylinder 202, which accommodates the housing 10 and forms a cylindrical gap portion 201 between it and an outer wall surface of the cylinder body 13 of the housing 10 of the filter 1; an upper lid 203 tightly plugging one end (the upper end in FIG. 5) of the cylinder 202; and a bottom member 204 tightly plugging the other end (the lower end in FIG. 5) of the cylinder 202.

In a central portion of the upper surface of the bottom member 204, provided is an fitting hole 205 fitting the discharge pipe 12a provided in and protruded from the bottom plate 14 of the housing 10 and connecting into the cylinder body 13 of the housing 10. The element 1 is accommodated in the accommodation cylinder 202 with the discharge pipe 12a being fitted in the fitting hole 205. On a side surface of the bottom member 204, provided are a water introduction port 207 connecting into the accommodating cylinder 202 via a throughhole 206, and a water supply port 208 connecting to the fitting hole 205. The water introduction port 207 and the water supply port 208 are installed with connection plugs 209, 210, respectively. Further, a screw-inserting hole 211 is formed in a central portion of the upper lid 203. The upper lid 203 is fixed to the accommodation cylinder 202 by screw engaging a screw 212 in the screw cylinder member 17 of the element 1 via the hole 211 and fastening the screw 212 with a nut member 213. While not shown in FIG. 5, connecting portions of the cylinder 202 with the upper lid 203 and with the bottom member 204 are structured so as to keep air tightness via a packing material or the like. Further, as described above, since the filter element 1 for water treatment as shown in FIG. 5 is one as disclosed in FIG. 1, the same components are given the same reference numerals, the explanation of which is omitted.

The water purifier 2 according to the embodiment as shown in FIG. 5 is constituted as above. Next, the use method and the like of the water purifier 2 will be described below. The connection plug 210 is connected with a nozzle pipe made of a bellows pipe or the like, and the connection plug 209 is connected to and set in a faucet of tap water, or the like. When a cock of the faucet or the like is opened, as shown by the arrows in FIG. 5, the water passes through the throughhole 206 from the water introduction port 207; enters into the gap portion 201 and rises therein; flows into the housing 10 from the water inlet 11; is treated upon passing through the first water treatment material 20 and the second water treatment material 30, as described above; passes through the water supply port 208 from the water outlet 12; and then flows out from the nozzle pipe.

Incidentally, the water purifier as shown in FIG. 5 is merely disclosed as one example, and as a matter of course, the shape of the water purifier and the like can be changed into an optional structure other than that as shown in FIG. 5.

(Test Example)

Since a test for removal properties of dioxins using the water purifier 2 as shown in FIG. 5 was carried out, the results obtained will be described below.

(Outline of Test Apparatus)

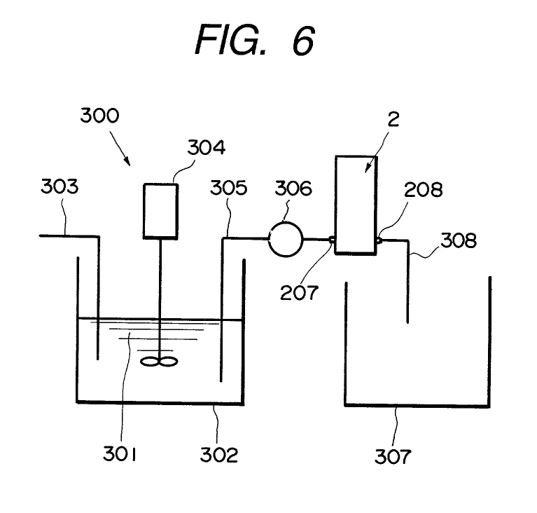

As shown in FIG. 6, a test apparatus 300 that was used in carrying out the test is provided with a water tank 302 accommodating raw water (tap water) 301 therein; a supply pipe 303 disposed such that one end thereof is connected to a faucet (not shown) of the tap water, with the other end being faced within the water tank 302; a stirrer 304 for stirring the water 301; a transporting pipe 305 disposed such that one end thereof is faced within the water tank 302, with the other end being connected to the water introduction port 207 of the water purifier 2; a liquid pump 306 provided on the route of the liquid transporting pipe 305, to feed the water 301 within the water tank 302 to the water purifier 2; and a discharge pipe 308 disposed such that one end thereof is connected to the water supply port 208 of the water purifier 2, with the other end being faced within a receiver tank 307.

(Outline of Test)

In order to examine a removal rate of dioxins by the water purifier 2, the test was carried out in the following procedures. The water (tap water) 301 is filled in the water tank 302, and a standard substance of dioxins is poured thereinto. After thoroughly stirring, the water 301 within the water tank 302 is fed into the water purifier 2 at a flow rate of 4.0 liters per minute via the pump 306.

As the standard substance of dioxins, a solution of 2,3,7,8-tetrachlorodibenzo-P-dioxin (abbreviated hereinafter as“2,3,7,8-TCDD”) ,which is the most toxic, in toluene is used, and a concentration thereof in the water tank 302 is set at 0.5 ng/l. The water that has passed through the water purifier 2 and entered into the receiver tank 307 is collected and taken as a sample for measurement of the dioxin concentration. The removal rate of dioxins by the water purifier 2 is calculated based on 0.5 ng/l, which is set as the concentration of the water 301 within the water tank 302.

(Test Procedures)

500 liters of the water (tap water) 301 is supplied into the water tank 302, to which is then added 25 μl of the standard substance of dioxins (0.25 μg; a concentration in the water: about 0.5 ng/l). Then, the stirrer 304 is actuated, thereby thoroughly diffusing and dissolving the dioxins within the water tank 302. Thereafter, the pump 306 is actuated, and the water 301 within the water tank 302 is discharged at a rate of 4.0 liters per minute through the pump 306 and the purifier 2 and stored within the receiver tank 307. The water that has passed through the water purifier 2 is collected and measured for the concentration of dioxins.

(Method for Measurement of Dioxins)

In the measurement of dioxins, a pre-treatment was carried out in accordance with the Notice dated Feb. 26, 1997, by the Director of Waste Management Division, Water Supply and Environ. Sanitation Department, Ministry of Health & Welfare, “Standard Analysis Manual of Dioxins in Treatment of Wastes”, and the concentration of dioxins was analyzed by the high resolution selective ion monitoring method of gas chromatographic mass analysis (GC/MS -HRSIM).

(Analysis Conditions of Gas Chromatographic Mass Analysis)

| | | |
|---|---|---|
| 1. | Gas chromatograph: | |
| | Device: | HP5890 Series II (manufactured |
| | | by Hewlett-Packard Company) |
| | Column: | SP-2331 (manufactured by |
| | | Supelco, Inc.) |
| | | Length: 60 m |
| | | Inner diameter: 0.32 mm |
| | | Film thickness: 0.2 μm |
| | Column temperature: | 100° C. (1.5 min.) − 20° C./min. − |
| | | 180° C. − 3° C./min. −260° C. |
| | Temperature of | 260° C. |
| | pouring inlet: | |
| | Carrier gas: | He |
| | Column head | 100 kPa |
| | pressure: | |
| | Pouring amount: | 2 μl |
| 2. | Mass analyzer: | |
| | Device: | VG - Autospec - Ultima E |
| | | (manufactured by Micromass |
| | | Inc.) |
| | Measurement method: | High resolution SIM method |
| | Resolution: | 10000 |
| | Ionization current: | 500 μA |
| | Ionization voltage: | 31 eV |
| | Acceleration | 8 kV |
| | voltage: | |
| | Ion source | 260° C. |
| | temperature: | |

(Results)

The results of the measurement (results of quantitation of 2,3,7,8-TCDD in the sample water) were as follows.

(1) Concentration of dioxins in the water having passed through the water purifier (pg/l): not detected (lower limit of detection: 1.0 pg/l)

(2) Removal rate of dioxins: 99.8% or more

As described above, no dioxins were detected from the water having passed through the water purifier 2, and the removal rate of dioxins was good as 99.8% or more (however, since the lower limit of detection is 1.0 pg/l, it could be said that the removal rate is substantially 100%) Thus, it has been proven that the water purifier 2 is useful for the removal of dioxins.

(Comparative Example)

A filter element was prepared by a constitution exactly the same as in the filter element 1 according to the above-described embodiment of the invention, except that instead of the water treatment material 20 made of a plurality of the layers 21a, 21b, 21c, 21d, 21e of the filter element 1 for water treatment of the water purifier 2, the ceramic solid 101 was filled in the cylinder body 13 of the housing 10 to form one layer by the ceramic solid 101. Using the thus prepared filter element, prepared was a water purifier similar to the water purifier 2 as shown in FIG. 5. Using this water purifier, the test for removal properties of dioxins was carried out in the same manner as described above. As a result, it was clarified that the removal rate of dioxins was 99.1% at maximum.

According to the present invention, it is possible to provide a filter element for water treatment capable of substantially completely removing dioxins contained in water.

While the present invention has been described in detail and with reference to specific embodiments thereof, it will be apparent to one skilled in the art that various changes and modifications can be made therein without departing from the spirit and scope thereof.

What is claimed is:

1. A filter element for water treatment having a water treatment material disposed within a housing with a water inlet and a water outlet, in which water passes through the housing and the water treatment material, wherein the water treatment material is constituted of a superposed layer of four layers or more layers, made of a ceramic solid containing a ferrous and ferric salt, and the ferrous and ferric salt is a compound represented by the following formula:
Fe⁺²ₘFe⁺³ₙCl₂ₘ₊₃ₙ
wherein m and n are each a positive integer.

2. The filter element for water treatment as claimed in claim 1, wherein each of the layers of the water treatment material is constituted by accommodating a desired number of the ceramic solids within a container provided with many small holes.

3. The filter element for water treatment as claimed in claim 1, wherein each of the layers of the water treatment material is constituted by accommodating a desired number of the ceramic solids within a network container.

4. The filter element for water treatment as claimed in claim 1, wherein each of the layers of the water treatment material is constituted by providing a partition to be inserted between the each two layers made of the ceramic solids.

5. The filter element for water treatment as claimed in claim 1, wherein the ceramic solids are formed in a ball-like state.

6. The filter element for water treatment as claimed in claim 1 or 5, wherein the ceramic solids are formed in a porous state with numerous fine pores.

7. The filter element for water treatment as claimed in claim 1, wherein a second water treatment material is disposed in a water passage within the housing.

8. The filter element for water treatment as claimed in claim 7, wherein the second water treatment material is constituted of one or more layers selected from a layer made of a calcium-containing material, a layer made of a dechlorinating agent, a layer made of active carbon, a layer made of a mineral components-containing solid, and a layer made of a ceramic material for pH adjustment.
